(19) United States
(12) Patent Application Publication
(10) Pub. No.: US 2016/0140086 A1
(43) Pub. Date: May 19, 2016

(54) SYSTEM AND METHOD FOR CONTENT REPAGINATION PROVIDING A PAGE CONTINUITY INDICIUM WHILE E-READING

(71) Applicant: Kobo Incorporated, Toronto (CA)

(72) Inventor: Kelsea O'CONNOR, Toronto (CA)

(73) Assignee: Kobo Incorporated, Toronto (CA)

(21) Appl. No.: 14/548,224

(22) Filed: Nov. 19, 2014

(51) Int. Cl. G06F 17/21; G06F 3/0483; G06F 3/0488

(52) U.S. Cl. CPC G06F 17/212; G06F 17/217; G06F 17/214; G06F 3/0488; G06F 3/0483

(57) ABSTRACT

A method and system for content repagination providing a page continuity indicium for e-reading. The method is executed in a processor of a computing device, the computing device further including a memory storing instructions and a display screen rendering e-book content including text formatted according to a series of digitally constructed pages, The method comprises receiving a repagination-inducing action at a current page being displayed, the current page having a beginning text portion and an ending text portion; reconstructing the current page by maintaining the beginning text portion while reflowing the ending text portion into a next page, the next page having a next page beginning text portion that includes at least a part of the reflowed ending text portion; and duplicating the next page beginning text portion onto an indicium location at the reconstructed current page, whereby the indicium location shows the next page beginning text portion.

### TECHNICAL FIELD

Examples described herein relate to a system and method for repaginating content rendered in pages on a display screen pertaining to digital reading of the content displayed thereon.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like).

Some electronic personal display devices are purpose built devices designed to perform especially well at displaying digitally-stored content for reading or viewing thereon. For example, a purpose built device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

As digital reading, or e-reading, of paginated digital content progresses, some shortcomings of the e-reading experience as compared with conventional printed become more apparent.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device configured for enacting repagination of displayed content in a manner that provides a successive-page continuity indicator, according to an embodiment.

FIG. 2 illustrates a schematic architecture configuration of a computing device for enacting repagination of displayed content in a manner that provides a successive-page continuity indicator, according to an embodiment.

FIGS. 3(a) and 3(b) and 3(c) illustrate an example configuration in an operation enacting repagination of displayed content in a manner that provides a successive-page continuity indicator, according to an embodiment.

FIG. 4 illustrates a method of operating a computing device to enact repagination of displayed content in a manner that provides a successive-page continuity indicator, according to an embodiment.

### DETAILED DESCRIPTION

One or more embodiments described herein may be implemented using programmatic modules or components. A programmatic module or component may include a program, a subroutine, a portion of a program, or a software or a hardware component capable of performing one or more stated tasks or functions in conjunction with one or more processors. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be stored on a computer-readable non-transitory medium. In particular, the numerous computing and communication devices shown with embodiments of the invention include processor(s) and various forms of computer memory, including volatile and non-volatile forms, storing data and instructions. Examples of computer-readable mediums include permanent memory storage devices, such as hard drives on personal computers or servers. Other examples of computer storage mediums include portable storage units, flash or solid state memory (such as carried on many cell phones and consumer electronic devices) and magnetic memory. Computers, terminals, network enabled devices (e.g., mobile devices such as cell phones and wearable computers) are all examples of machines and devices that utilize processors, memory, and instructions stored on computer-readable mediums. Additionally, embodiments may be implemented in the form of computer-programs, or a computer usable storage medium capable of storing such a program.

In regard to paginated digital content displayed on e-reading devices for viewing or reading by an observer, a page transition input command causes a new page to supersede a previous page on the display. For an instant during the page transition, the observer may not perceive with certainty that the page transition has actually happened; in contrast while turning a page of a printed publication, no such uncertainty is generated in perception of the observer, since they actually effect the page turn. For e-reading page transitions, upon a page transition action performed, one approach has been to overlay an animation of a page being flipped in an instant before the new page is rendered. Another, more obvious solution, is to provide page numbers on each page of paginated content, whereby the observer may glance at respective page numbers and mentally confirm that the requested page transition has been effected by comparing the page numbers before and after the request, as rendered on the display screen. However, this approach has the disadvantage that, at least just for the briefest instant, it interrupts and intrudes on the observer's reading experience by requiring to mentally track page numbers, and thus continuity of the reading experience may elude the observer. Providing a continuity indicium that keeps the observer engaged within the reading experience even during page transitions would therefore be beneficial to the e-reading experience.

“E-books” are a form of electronic publication content stored in digital format in a computer non-transitory memory, viewable on a computing device having display functionality. An e-book can comprise a series of digitally constructed pages of content arranged in particular sequence to correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, sonic devices (sometimes labeled as “e-readers”) can display digitally-stored content in a more reading-centric manner, while also providing, via a user input interface, the ability to manipulate that content for viewing, such as via discrete pages arranged sequentially (that is, pagination) corresponding to an intended or natural reading progression or flow of content therein.

An “e-reading device”, also referred to herein as an electronic personal display, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

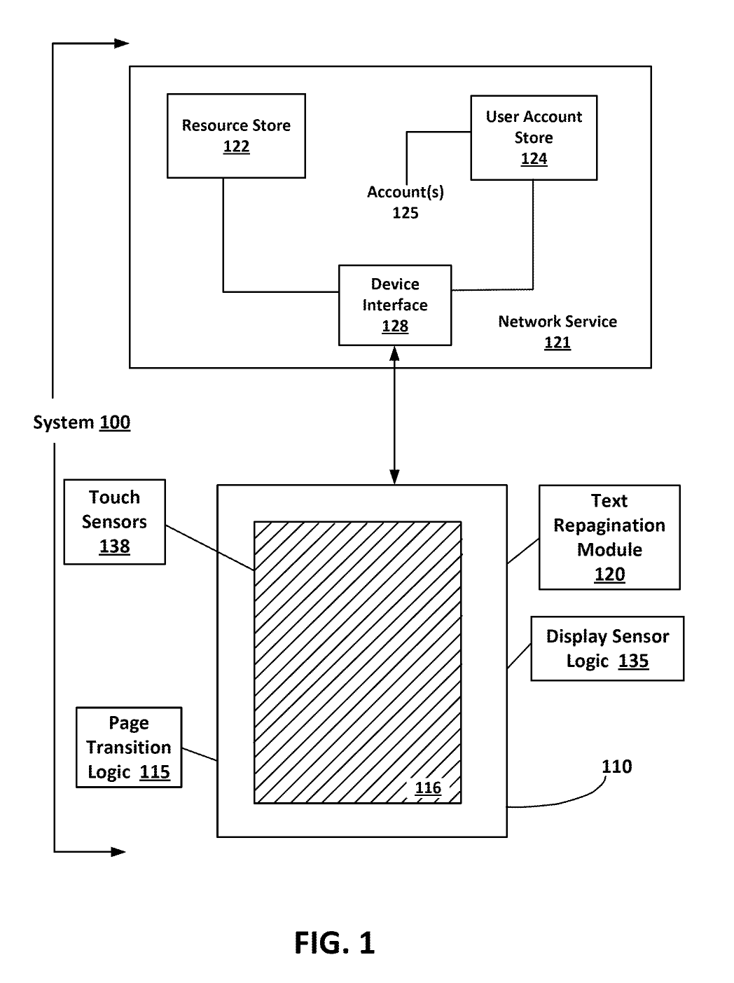

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 121. The network service 121 can include multiple servers and other computing resources that provide various services in connection with one or more applications that are installed on the e-reading device 110. By way of example, in one implementation, the network service 121 can provide e-book services that communicate with the e-reading device 110. The e-book services provided through network service 121 can, for example, include services in which e-books are sold, shared, downloaded and/or stored. More generally, the network service 121 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 121 and enables e-books provided through the service to be viewed and consumed. In another implementation, the e-reading device 110 can run a media playback or streaming application that receives files or streaming data from the network service 121. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can have an E-ink display.

In additional detail, network service 121 can include a device interface 128, a resource store 122 and a user account store 124. User account store 124 can associate e-reading device 110 with a user and an associated account 125. The account 125 can also be associated with one or more application resources (e.g., e-books), which can be stored in the resource store 122. The device interface 128 can handle requests from e-reading device 110, and further interface the requests of the device with services and functionality of the network service 121. The device interface 128 can utilize information provided with user account 125 in order to enable services, such as purchasing downloads or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user. In an embodiment, resource store 122 may house an electronic library (e-library) of e-books and digital content associated with account 125.

Yet further, the user account store 124 can retain metadata for individual accounts 125 to identify resources that have been purchased or made available for consumption for a given user account 125. Multiple e-reading devices 110 may be associated with a same user account 125. As described in greater detail below, the e-reading device 110 can locally store resources (e.g., e-books) that are purchased or otherwise made available to the user of the e-reading device 110, as well as to archive e-books and other digital content items that have been purchased for the user account 125, and are not locally stored on the particular computing device, but rather are stored remotely via resource store 122.

With reference to an example of FIG. 1, e-reading device 110 can include a display screen 116 and a housing. In an embodiment, the display screen 116 is touch-sensitive, to process touch inputs including gestures (e.g., swipes). For example, the display screen 116 may be integrated with one or more touch sensors 138 to provide a touch-sensing region on a surface of the display screen 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered according to successive ones of digital pages arranged in a predetermined or fixed sequence, and the e-book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In the specific example embodiment where a given page state coincides with a single page, for instance, each page state corresponding to one page of the digitally constructed series of pages paginated to comprise, in one embodiment, an e-book. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch sensing region of the display screen 116. For example, the user may swipe the surface of the display screen 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display screen 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display screen 116.

According to some embodiments, the e-reading device 110 includes display sensor logic 135 to detect and interpret user input or user input commands made through interaction with the touch sensors 138. By way of example, display sensor logic 135 can detect a user making contact with the touch-sensing region of the display screen 116. More specifically, display sensor logic 135 can detect taps, an initial tap held in sustained contact or proximity with display screen 116 (otherwise known as a “long press”), multiple taps performed either sequentially or generally simultaneously, swiping gesture actions made through user interaction with the touch sensing region of the display screen 116, or any combination of these gesture actions. Furthermore, display sensor logic 135 can interpret such interactions in a variety of ways. For example, each interaction may be interpreted as a particular type of user input causing a respective change in state of display 116.

In one implementation, display sensor logic 135 implements operations to monitor for the user contacting or superimposing thereupon, a finger, thumb or stylus, a surface of display 116 coinciding with a placement of one or more touch sensor components 138 and also detects and correlates a particular gesture (e.g., pinching, swiping, tapping, etc.) as a particular type of input or user action. Display sensor logic 135 may also sense directionality of a user gesture action so as to distinguish between, for example, leftward, rightward, upward, downward and diagonal swipes for the purpose of associating respective input commands therewith.

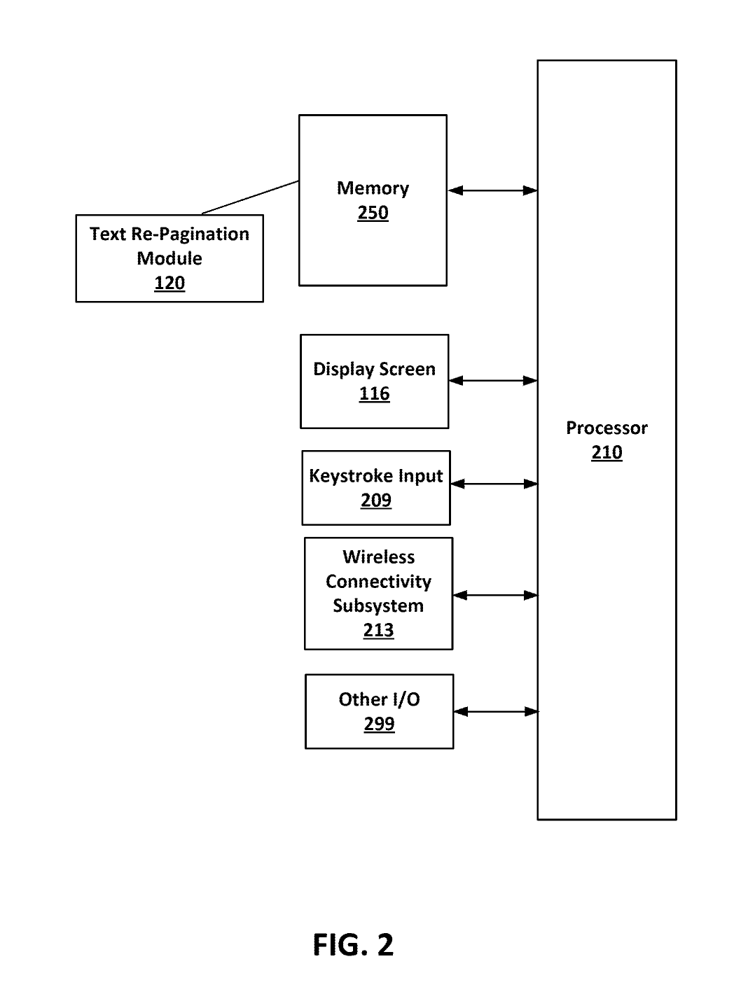

Text repagination module 120 can be implemented as a software module comprising instructions stored in a memory of mobile computing device 110, as described in further detail below with regard to FIG. 2.

FIG. 2 illustrates further detail of e-reading device 110 as described above with respect to FIG. 1, in a schematic architecture according to an embodiment. E-reading device 110 further includes processor 210, a memory 250 storing instructions and logic pertaining at least to display sensor logic 135 and text repagination module 120.

Processor 210 can implement functionality using the logic and instructions stored in memory 250. Additionally, in some implementations, processor 210 utilizes the network interface 220 to communicate with the network service 121 (see FIG. 1). More specifically, the e-reading device 110 can access network service 121 to receive various kinds of resources (e.g., digital content items such as e-books, configuration files, account information), as well as to provide information (e.g., user account information, service requests etc.). For example, e-reading device 110 can receive application resources, such as e-books or media files, that the user elects to purchase or otherwise download via the network service 121. The application resources that are downloaded onto the e-reading device 110 can be stored in memory 250.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can receive input from various sources, including touch sensor components 138, display 116, keystroke input 208 such as from a virtual or rendered keyboard, and other input mechanisms 299 (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-book activities such as generating e-book content on display 116, performing page transitions of the displayed e-book content, powering off the device 110 and/or display 116, activating a screen saver, launching or closing an application, and/or otherwise altering a state of display 116 such as by changing a font size of text of e-book content rendered thereon.

In some embodiments, memory 250 may store display sensor logic 135 that monitors for user interactions detected through the touch sensor components 138, and further processes the user interactions as a particular input or type of input. In an alternative embodiment, display sensor logic module 135 may be integrated with the touch sensor components 138. For example, the touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

E-reading device 110 further includes wireless connectivity subsystem 213, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of wireless connectivity subsystem 213 depends on the communication network in which computing device 110 is intended to operate, such as in accordance with Wi-Fi, Bluetooth, Near Field Communication (NFC) communication protocols, and the like.

Text repagination module 120 can be implemented as a software module, comprising instructions stored in memory 250, on mobile computing device 110. One or more embodiments of text repagination module 120 described herein may be implemented using programmatic modules or components, a portion of a program, or software in conjunction with one or more hardware component(s) capable of performing one or more stated tasks or functions. As used herein, such module or component can exist on a hardware component independently of other modules or components. Alternatively, a module or component can be a shared element or process of other modules, programs or machines.

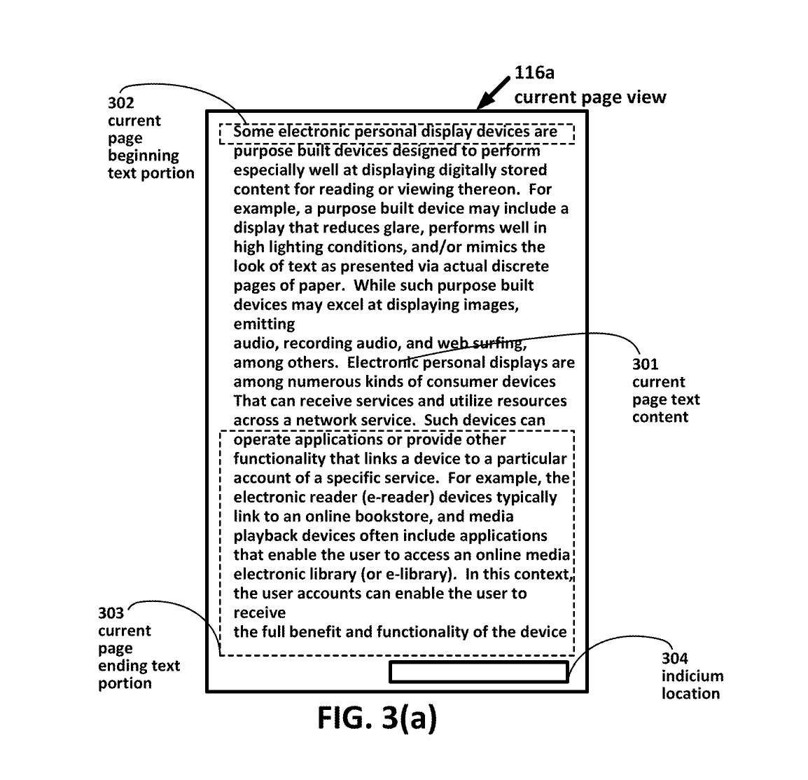

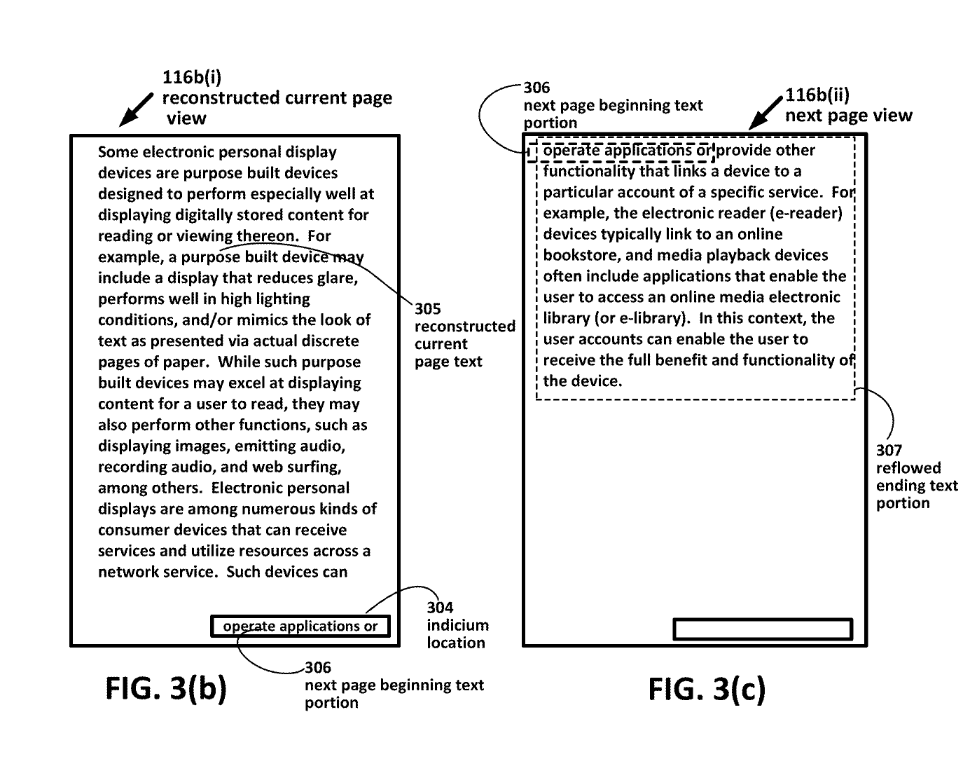

With reference now to FIG. 3(a) in conjunction with FIGS. 3(b) and 3(c), an embodiment implementation of text repagination module 120 in operation of computing device 110 is described in further detail.

In FIG. 3(a), display screen 116a of computing device 110 shows text content 301 of a digitally rendered current page among a series or sequence of digitally constructed pages forming an e-book. For an electronic book (e-book), the page may displayed in distinct, separate pages, paginated sequentially to mimic successive pages of a printed paper book, for example. The text content 301 further comprises lines of text for reading by an observer or reader, the text having text attributes, such as, but not limited to, a font size, a font type, a spacing between the lines, a spacing between words of text, and a margin space around text content 301 comprising the distances from the left, right, top and bottom margins of the electronic page to text content 301. In the example depicted in FIG. 3(a), it is apparent that a natural or intended reading progression for an observer viewing display screen 116 would be to start from upper left-most word, then read lines in sequential order until reaching the bottom-right-most text word. It is contemplated that the displayed page of current page text content 301 may further include one or more graphic image(s) interspersed within the lines of text (not depicted). Current page text content 301 includes a current page beginning text portion 302 and ending text portion 303, with indicium location 304 provided (as will be described further below).

With regard now to FIG. 3(b), text paginating module 120 monitors for receipt of any repaginating-inducing actions at computing device 110, and responds accordingly as described further herein. A repaginating-inducing action comprises an input command which results in repagination of text content 301 for viewing as appropriate by an observer of display screen 116. Specifically, 116b(i) shows a display view of a reconstructed current page resulting from, or induced by, a repagination action. In the embodiment depicted, such repagination-inducing action comprises execution of a font size increase command at processor 210, wherein reconstructed current page text 305 includes current page beginning text portion 302, but ending text portion 303 is reflowed onto a next page 307, as depicted in next page view 116b(ii) of FIG. 3(c). In this manner the lines of text content 301 are repaginated to reflow over into next page view 116b(ii) while maintaining text attributes such as font size, text spacing, word spacing, etc. for continuity in reading by the observer. Referring to the specific example embodiment depicted in FIG. 3(b), a consequent effect in such line-wrapping of repaginated text portion 306, is that the last line of text content 301, depicted as repaginated line 307, is no longer viewable on display screen 116, and instead is repaginated into a next page in the sequence of digitally constructed pages comprising the e-book being read by the observer.

Reflowed ending text portion 307 includes next page beginning text portion 306, typically comprising of about 3 to 5 words of text, which when duplicated therefrom and populated into indicium location 304, provides a common link between the reconstructed current page of view 116b(i) and next page view 116b(ii) for e-reading. Indicium location 304 may be rendered visually different from adjacent text content 301, such as by color, shading, text font size of included text, or any combination thereof.

Another pagination-inducing action received at computing device 110 may be from an observer's finger, thumb or a stylus device, superposed upon a touchscreen embodiment of display 116, sensed via touch sensors 138. Text repagination module 120 may then be triggered to re-arrange display of lines of text content 301 around the object in order to counteract obscuration of said content by the superposed object for satisfactory reading or viewing, thereby necessitating repagination of text content 301.

In this manner, text repagination module 120 operates to repaginate digitally constructed e-book pages and respectively populate associated indicium locations 304, as the above described repagination of current page text content 301 conceivably ripples throughout a series of following or subsequent digitally constructed pages of the e-book being viewed or read one page at a time.

Yet further, in an embodiment where the computing device comprises an electronic reading device displaying paginated content comprising an e-magazine or e-comic book at the display screen, it is contemplated that the device memory further stores instructions to enact similar operations where one or more image(s), including graphical images(s), are interspersed within text content 301, or form a predominant portion of content for rendering on display screen 116.

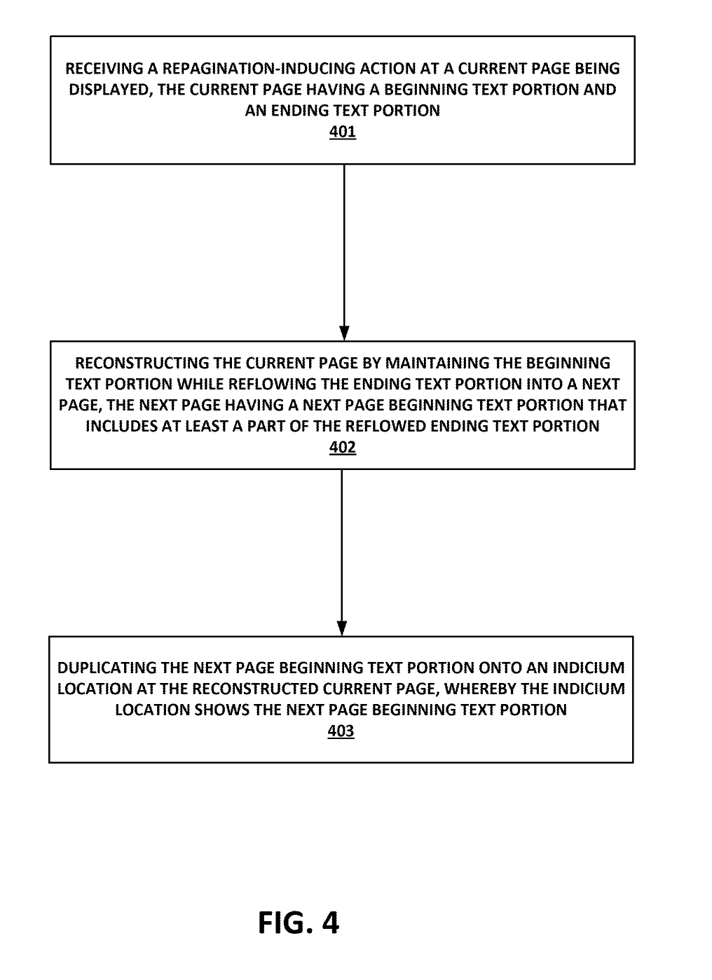

FIG. 4 illustrates an example method implemented by processor 210 of computing device 110 for enacting a repagination operation upon text content of e-book pages arranged sequentially, to provide a page continuity indicium for e-reading, according to some embodiments using elements such as described with prior examples, including those of FIGS. 1-3(c).

At step 401, receiving a repagination-inducing action at a current page 301 being displayed, the current page having a beginning text portion 302 and an ending text portion 303.

At step 402, reconstructing the current page by maintaining the beginning text portion 302 while reflowing the ending text portion 303 into a next page, the next page having a next page beginning text portion 306 that includes at least a part of the reflowed ending text portion 303.

At step 403, duplicating the next page beginning text portion 306 onto an indicium location 304 at the reconstructed current page, whereby the indicium location 304 shows the next page beginning text portion 306.

Although illustrative embodiments have been described in detail herein with reference to the accompanying drawings, variations to specific embodiments and details are contemplated and encompassed by this disclosure. For instance, instead of a repagination-inducing action that reflows text onto a next page, text could be reflowed from a next page into the current page such as when a font size reduction is effected on text of the first page. Thus the indicium in this case is populated with a beginning text portion of the next page as reconstructed by the text reflow from that next page into the current page, and functions at least in part to keep the observer within the reading experience with regard to content of the e-book.

It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method executed in a processor of a computing device, the computing device further including a memory storing instructions and a display screen rendering e-book content including text formatted according to a series of digitally constructed pages, the method comprising:
receiving a repagination-inducing action at a current page being displayed, the current page having a beginning text portion and an ending text portion;
reconstructing the current page by maintaining the beginning text portion while reflowing the ending text portion into a next page, the next page having a next page beginning text portion that includes at least a part of the reflowed ending text portion; and
duplicating the next page beginning text portion onto an indicium location at the reconstructed current page;
whereby the indicium location shows the next page beginning text portion.

2. The method of claim 1 wherein the indicium location is along a bottom edge of the reconstructed current page as displayed on the display screen.

3. The method of claim 2 wherein the content of the current page further includes one or more images interspersed among the text therein.

4. The method of claim 1 wherein the next page beginning text portion comprises three to five words of text.

5. The method of claim 1 wherein indicium location is rendered visually differently from text content of the reconstructed current page.

6. The method of claim 5 wherein the different visual rendering comprises one of: a shading, a color, and a text font size visually contrasting with text content of the reconstructed current page.

7. The method of claim 1 wherein the text of the current page comprises an attribute selected from the group of text attributes consisting of: a font size, a word spacing, a line spacing, and a font type.

8. The method of claim 7 wherein reflow of the ending text portion preserves a text attribute selected from the group of text attributes.

9. The method of claim 1 wherein the repagination-inducing action comprises a font size change enacted upon text of the current page.

10. The method of claim 1 wherein the display screen comprises a touch screen display.

11. The method of claim 10 wherein the repagination-inducing action comprises one of a thumb, a finger and a stylus superposed upon text of the current page at the touchscreen display.

12. A computer-readable medium that stores instructions for a computing device, the computing device including a processor, a memory and a display screen rendering e-book content including text formatted according to a series of digitally constructed pages, the instructions being executable by the processor to cause the computing device to perform operations that include:
receiving a repagination-inducing action at a current page being displayed, the current page having a beginning text portion and an ending text portion;
reconstructing the current page by maintaining the beginning text portion while reflowing the ending text portion into a next page, the next page having a next page beginning text portion that includes at least a part of the reflowed ending text portion; and
duplicating the next page beginning text portion onto an indicium location at the reconstructed current page;
whereby the indicium location shows the next page beginning text portion.

13. A computing device comprising:
a memory that stores a set of instructions;
a display screen rendering e-book content including text formatted according to a series of digitally constructed pages;
a processor that access the instructions in memory, the processor further configured to:
receive a repagination-inducing action at a current page being displayed, the current page having a beginning text portion and an ending text portion;
reconstruct the current page by maintaining the beginning text portion while reflowing the ending text portion into a next page, the next page having a next page beginning text portion that includes at least a part of the reflowed ending text portion; and
duplicate the next page beginning text portion onto an indicium location at the reconstructed current page;
whereby the indicium location shows the next page beginning text portion.

14. The computing device of claim 13 wherein the indicium location is along a bottom edge of the reconstructed current page as displayed on the display screen.

15. The computing device of claim 13 wherein the next page beginning text portion comprises three to five words of text.

16. The computing device of claim 13 wherein indicium location is rendered visually differently from text content of the reconstructed current page.

17. The computing device of claim 16 wherein the different visual rendering comprises one of: a shading, a color, and a text font size visually contrasting with text content of the reconstructed current page.

18. The computing device of claim 13 wherein the repagination-inducing action comprises a font size change enacted upon text of the current page.

19. The computing device of claim 13 wherein the display screen comprises a touch screen display.

20. The computing device of claim 13 wherein the repagination-inducing action comprises an object superposed upon text of the current page at the touchscreen display.

21. The computing device of claim 13 wherein the object superposed on the content is one of: a thumb, a stylus and a finger digit.
